(19) United States
(12) Patent Application Publication
(10) Pub. No.: US 2010/0232183 A1
(43) Pub. Date: Sep. 16, 2010

(54) CONTROL CIRCUIT OF RESONANT POWER CONVERTER WITH ASYMMETRICAL PHASE SHIFT TO IMPROVE THE OPERATION

(75) Inventor: TA-YUNG YANG, MILPITAS, CA (US)

Correspondence Address: ROSENBERG, KLEIN & LEE, 3458 ELLICOTT CENTER DRIVE-SUITE 101, ELLICOTT CITY, MD, 21043, US

(73) Assignee: SYSTEM GENERAL CORP., TAIPEI HSIEN (TW)

(21) Appl. No.: 12/720,915

(22) Filed: Mar. 10, 2010

Related U.S. Application Data
(60) Provisional application No. 61/210,113, filed on Mar. 12, 2009.

(51) Int. Cl. H02M 3/335

(52) U.S. Cl. 363/21.02

(57) ABSTRACT

A control circuit of the resonant power converter according to the present invention comprises a frequency modulation circuit modulating a switching frequency of a switching signal in response to a feedback signal in a first operation range. A phase-shift circuit performs a phase-shift modulation to the switching signal in response to the feedback signal in a second operation range. A burst circuit performs a burst modulation to the switching signal in response to the feedback signal in a third operation range. The control circuit is operated in the first operation range when the feedback signal is higher than a first threshold. The control circuit is operated in the second operation range when the feedback signal is lower than the first threshold and higher than a second threshold. The control circuit is operated in the third operation range when the feedback signal is lower than the second threshold.

### BACKGROUND OF THE INVENTION

1. Field of the Invention

The present invention relates to power converters, and more particularly, relates to the soft switching power converters.

2. Description of the Related Art

The resonant power converter is a high efficiency power converter. Its prior art can be found in “Switching controller for resonant power converter” by Yang et al., U.S. Pat. No. 7,313,004. The drawback of the resonant power converter is its narrow operation range. When the load has a significantly change, its operation might fall into a non-linear region. The object of the present invention is to provide a control scheme to solve this problem. It allows the resonant power converter can be operated in a wide operation range.

### BRIEF SUMMARY OF THE INVENTION

A control circuit is developed to extend the operation range of the resonant power converter and further improve efficiency. The control circuit comprises a frequency modulation circuit, a phase-shift circuit and a burst circuit. The frequency modulation circuit modulates a switching frequency of a switching signal in response to a feedback signal in a first operation range. The phase-shift circuit performs a phase-shift modulation to the switching signal in response to the feedback signal in a second operation range. The burst circuit performs a burst modulation to the switching signal in response to the feedback signal in a third operation range. The control circuit is coupled to an output of the power converter to receive the feedback signal for regulating the output of the power converter. The control circuit is operated in the first operation range when the feedback signal is higher than a first threshold. The control circuit is operated in the second operation range when the feedback signal is lower than the first threshold and higher than a second threshold. The control circuit is operated in the third operation range when the feedback signal is lower than the second threshold.

### BRIEF DESCRIPTION OF THE DRAWINGS

The invention can be more fully understood by reading the subsequent detailed description and examples with references made to the accompanying drawings, wherein:

FIG. 1 shows a circuit diagram of a preferred embodiment of a power converter in accordance with the present invention.

FIG. 2 shows a circuit diagram of a preferred embodiment of the control circuit in accordance with the present invention.

FIG. 3 shows a circuit diagram of a preferred embodiment of the frequency generation circuit in accordance with the present invention.

FIG. 4 shows a circuit diagram of a preferred embodiment of the signal generation circuit in accordance with the present invention.

FIG. 5 shows a circuit diagram of a preferred embodiment of the phase-shift circuit in accordance with the present invention.

FIG. 6 is a circuit diagram of a preferred embodiment of the delta circuit in accordance with the present invention.

FIG. 7 shows a circuit diagram of a preferred embodiment of the phase modulation circuit in accordance with the present invention.

FIG. 8 is a circuit diagram of a preferred embodiment of the output circuit in accordance with the present invention.

FIG. 9 shows a circuit diagram of a preferred embodiment of delay time circuits in accordance with the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

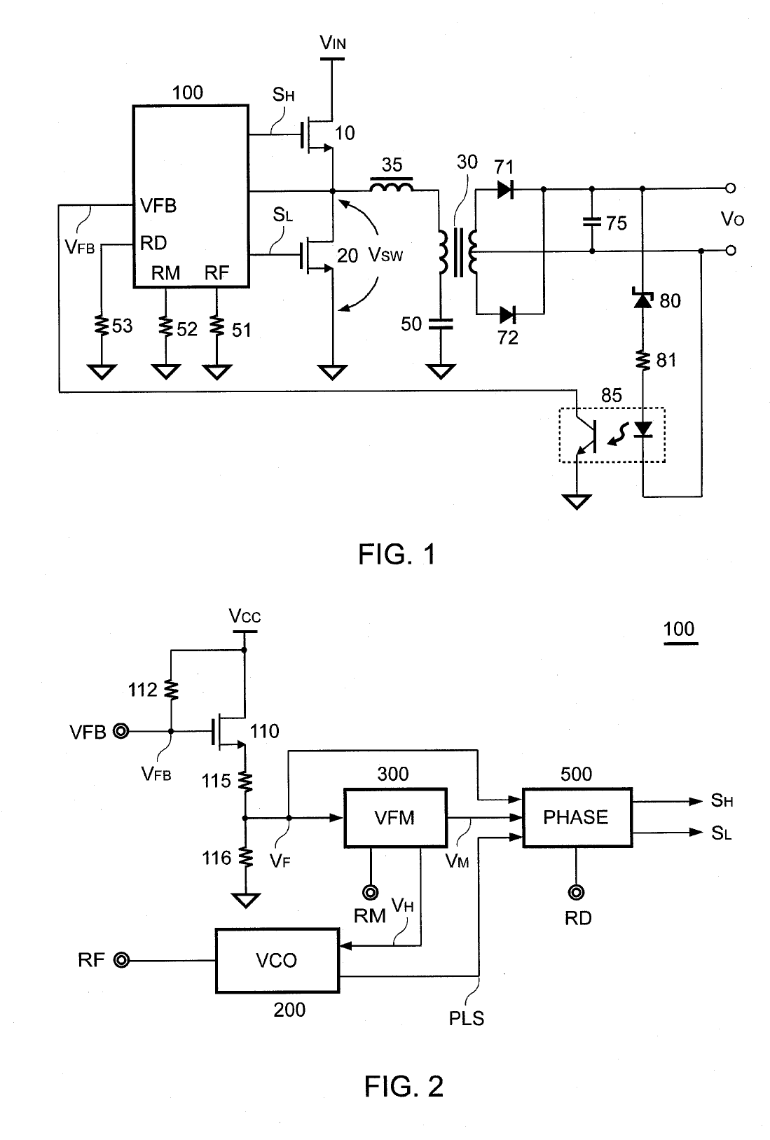

FIG. 1 is a preferred embodiment of a power converter in accordance with the present invention. A capacitor 50 and an inductive device (such as a transformer 30, its parasitic inductor 35) develop a resonant tank. The capacitor 50 is connected from a terminal of the primary winding of the transformer 30 to the ground. Therefore, the capacitor 50 is coupled to the inductive device. Transistors 10 and 20 are coupled to switch the resonant tank. A drain terminal of the transistor 10 is coupled to an input voltage V_{IN}. A source terminal of the transistor 10 is connected to a drain terminal of the transistor 20. The source terminal of the transistor 10 and the drain terminal of the transistor 20 are connected to another terminal of the primary winding of the transformer 30 via its parasitic inductor 35. A source terminal of the transistor 20 is coupled to the ground. Two rectifiers 71 and 72 are connected from the secondary winding of the transformer 30 to an output capacitor 75 for generating an output voltage V_{O}. The output voltage V_{O} is generated at the output capacitor 75.

A control circuit 100 generates a switching signal comprising switching signals S_{H} and S_{L} coupled to gate terminals of the transistors 10 and 20 to control the transistors 10 and 20 respectively. The first switching signal S_{H} is contrast with the second switching signal S_{L}. The pulse widths of the switching signals S_{H} and S_{L} are modulated in accordance with a feedback signal V_{FB} for regulating the output voltage V_{O} of the power converter. Therefore, the switching frequency of the switching signals S_{H} and S_{L} is varied in accordance with the feedback signal V_{FB} for regulating the output V_{O} of the power converter. The control circuit 100 is coupled to the output voltage V_{O} of the power converter to receive the feedback signal V_{FB}. The feedback signal V_{FB} is generated at a VFB terminal. A zener diode 80, a resistor 81 and an optocoupler 85 form a feedback circuit coupled to the output voltage V_{O} of the power converter to generate the feedback signal V_{FB}.

A resistor 53 is connected to a delay time terminal RD of the control circuit 100 to determine delay times (dead times). The delay times are inserted between the turning on and turning off the switching signals S_{H} and S_{L} for achieving soft switching of the transistors 10, 20. Therefore, the control circuit 100 further generates the delay times for achieving soft switching. A resistor 51 is connected to a RF terminal of the control circuit 100 to determine a minimum switching frequency of the switching signals S_{H} and S_{L}. A resistor 52 coupled to a RM terminal of the control circuit 100 is applied to determine a maximum switching frequency of the switching signals S_{H} and S_{L}.

The control circuit 100 includes:
(1) A frequency modulation circuit inside a frequency generation circuit 200 (shown in FIG. 2) modulates the switching frequency of the switching signal in response to the feedback signal V_{FB} in a first operation range. It means that the switching frequency of the first switching signal S_{H} and the second switching signal S_{L} of the switching signal are modulated in response to the feedback signal V_{FB} in the first operation range. When the output load of the power converter is decreased, the switching frequency of the switching signals S_{H}, S_{L} will be increased to regulate the output voltage V_{O}.
(2) A phase modulation circuit 700 inside a phase-shift circuit 500 (shown in FIG. 5) will perform a phase-shift modulation to the switching signals S_{H}, S_{L} in response to the feedback signal V_{FB} in a second operation range. Once the switching frequency is increased up to the maximum switching frequency set by the resistor 52, the control circuit 100 will perform the phase shift modulation to the switching signals S_{H}, S_{L}. The pulse width of the first switching signal S_{H} is decreased and the pulse width of the second switching signal S_{L} is increased during the phase-shift modulation.
(3) A burst circuit inside the phase modulation circuit 700 (shown in FIG. 5) will perform a burst modulation to the switching signals S_{H}, S_{L} in response to the feedback signal V_{FB} in a third operation range. If the pulse width of the first switching signal S_{H} is decreased to a minimum pulse width threshold, then the switching signals S_{H}, S_{L} will be turned on/off as a burst mode. The minimum pulse width of the first switching signal S_{H} is required for providing enough energy to achieve the phase-shift soft switching.

The control circuit 100 is operated in the first operation range when the feedback signal V_{FB} is higher than a first threshold. The control circuit 100 is operated in the second operation range when the feedback signal V_{FB} is lower than the first threshold and higher than a second threshold V_{TH} (shown in FIG. 7). The control circuit 100 is operated in the third operation range when the feedback signal V_{FB} is lower than the second threshold V_{TH}.

FIG. 2 is a preferred embodiment of the control circuit 100 in accordance with the present invention. It includes a level-shift circuit coupled to the output voltage V_{O} to receive the feedback signal V_{FB} and generate a level-shift signal V_{F}. The level-shift signal V_{F} is correlated to the feedback signal V_{FB}. A transistor 110 and resistors 115, 116 form the level-shift circuit. A resistor 112 provides a pull high to the feedback signal V_{FB}. The transistor 110 and the resistors 112, 115, and 116 develop a feedback-input circuit. A drain terminal of the transistor 110 is coupled to receive a supply voltage V_{CC}. A gate terminal of the transistor 110 is coupled to the VFB terminal to receive the feedback signal V_{FB}. The resistor 112 is connected from the drain terminal of the transistor 110 to the gate terminal of the transistor 110. One terminal of the resistor 115 is connected to a source terminal of the transistor 110. The resistor 116 is connected from another terminal of the resistor 115 to the ground. Another terminal of the resistor 115 outputs the level-shift signal V_{F}.

A signal generation circuit 300 (VFM) receives the level-shift signal V_{F}. The resistor 52 is coupled to the signal generation circuit 300 through the RM terminal of the control circuit 100 (shown in FIG. 1). The signal generation circuit 300 generates a trip-point signal V_{H} and a maximum frequency signal V_{M} in accordance with the level-shift signal V_{F} and the resistance of the resistor 52. The frequency generation circuit 200 (VCO) receives the trip-point signal V_{H}. The resistor 51 is connected to the frequency generation circuit 200 through the RF terminal of the control circuit 100 (shown in FIG. 1). The frequency generation circuit 200 generates a frequency signal PLS for modulating the switching frequency of the switching signals S_{H}, S_{L} in accordance with the trip-point signal V_{H} and the resistance of the resistor 51. The resistor 53 is connected to the phase-shift circuit 500 (PHASE) through the delay time terminal RD of the control circuit 100 (shown in FIG. 1). The phase-shift circuit 500 generates the switching signals S_{H}, S_{L} in response to the resistance of the resistor 53, the frequency signal PLS, the level-shift signal V_{F} and the maximum frequency signal V_{M}.

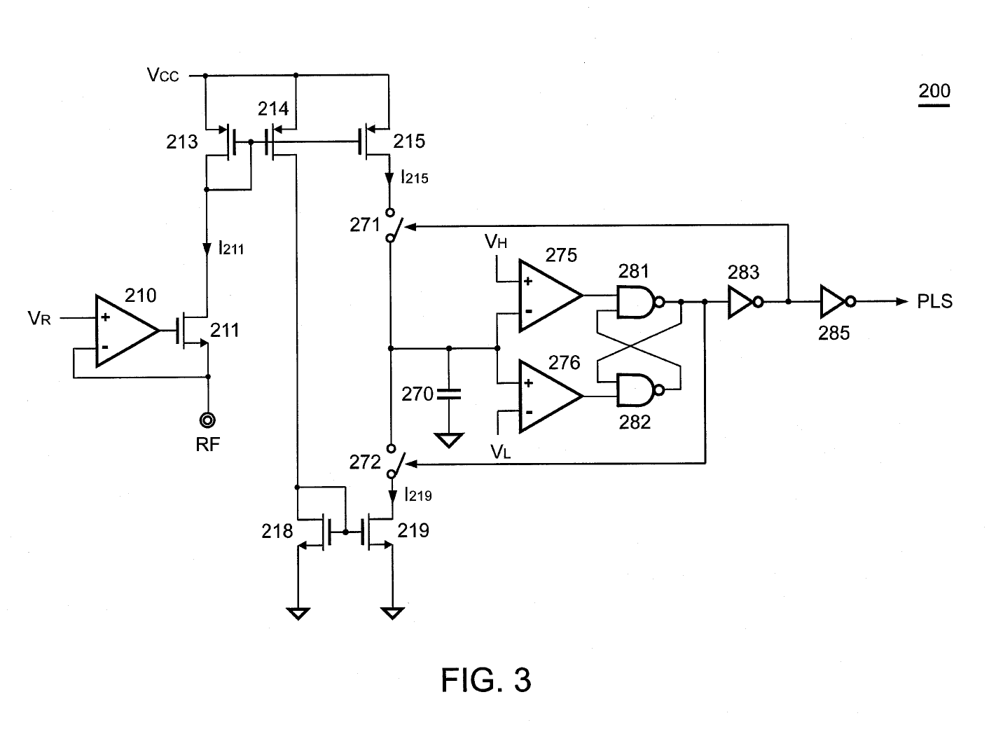

FIG. 3 is a preferred embodiment of the frequency generation circuit 200 in accordance with the present invention. It includes a minimum frequency circuit and a frequency modulation circuit. An operational amplifier 210 and a transistor 211 develop the minimum frequency circuit. The minimum frequency circuit associates with the resistor 51 (shown in FIG. 1) for generating a minimum frequency signal I₂₁₁ to determine the minimum switching frequency for the switching signal. A positive input of the operational amplifier 210 receives a reference signal V_{R}. A negative input of the operational amplifier 210 is coupled to a source terminal of the transistor 211. The resistor 51 at the RF terminal is coupled to the source terminal of the transistor 211 and the negative input of the operational amplifier 210 through the RF terminal of the control circuit 100 (shown in FIG. 1). An output of the operational amplifier 210 is coupled to a gate terminal of the transistor 211. The minimum frequency signal I₂₁₁ is generated at a drain terminal of the transistor 211. Switches 271, 272, a capacitor 270, comparators 275, 276, NAND gates 281, 282 and inverters 283, 285 develop the frequency modulation circuit. Through current mirrors formed by transistors 213, 214, 215, 218 and 219, the minimum frequency signal I₂₁₁ generates a charge current I₂₁₅ and a discharge current I₂₁₉ for the frequency modulation circuit.

Referring to FIG. 3, source terminals of the transistors 213, 214 and 215 are coupled to the supply voltage V_{CC}. Gate terminals of the transistors 213, 214, 215 and drain terminals of the transistors 213, 211 are connected together. A drain terminal of the transistor 215 generates the charge current I₂₁₅ in response to the minimum frequency signal I₂₁₁. Source terminals of the transistors 218 and 219 are coupled to the ground. Gate terminals of the transistors 218, 219 and drain terminals of the transistors 218, 214 are connected together. A drain terminal of the transistor 219 generates the discharge current I₂₁₉ in response to the minimum frequency signal I₂₁₁. The charge current I₂₁₅ and the discharge current I₂₁₉ are coupled to the capacitor 270 via the switches 271, 272. A first terminal of the switch 271 is coupled to the drain terminal of the transistor 215 to receive the charge current I₂₁₅. A first terminal of the switch 272 is coupled to the drain terminal of the transistor 219 to receive the discharge current I₂₁₉. Second terminals of the switches 271 and 272 are coupled to a first terminal of the capacitor 270. A second terminal of the capacitor 270 is coupled to the ground.

A positive input of the comparator 275 receives the trip-point signal V_{H}. A negative input of the comparator 276 receives a low-level signal V_{L}. A negative input of the comparator 275 and a positive input of the comparator 276 are coupled to the first terminal of the capacitor 270, the second terminals of the switches 271 and 272. A first terminal of the NAND gate 281 is coupled to an output of the comparator 275. A first terminal of the NAND gate 282 is coupled to an output of the comparator 276. An output of the NAND gate 281 is coupled to a second terminal of the NAND gate 282. An output of the NAND gate 282 is coupled to a second terminal of the NAND gate 281. An input of the inverter 283 is coupled to the output of the NAND gate 281 and controls the switch 272. An input of the inverter 285 is coupled to an output of the inverter 283 and controls the switch 271. An output of the inverter 285 generates the frequency signal PLS. Therefore, the frequency modulation circuit is coupled to receive the charge current I₂₁₅ and the discharge current I₂₁₉ for generating the frequency signal PLS. The trip-point signal V_{H} determines a trip-point voltage for the frequency modulation circuit. The minimum frequency signal I₂₁₁ and the trip-point voltage of the trip-point signal V_{H} determine the switching frequency of the switching signals S_{H}, S_{L}.

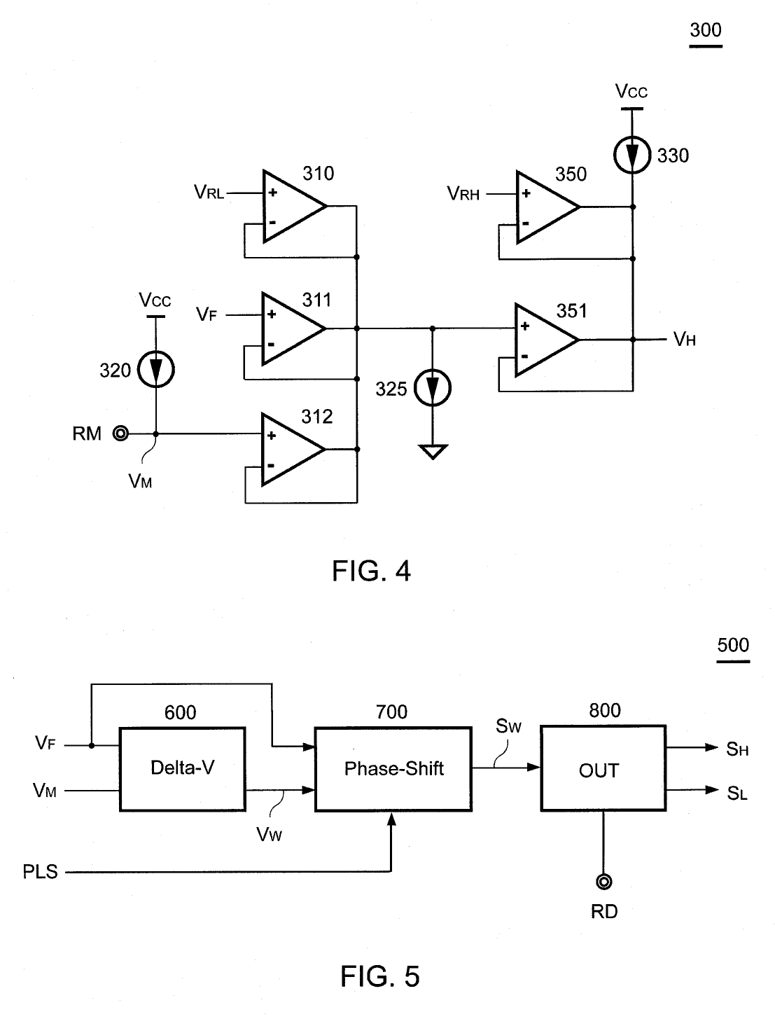

FIG. 4 is a preferred embodiment of the signal generation circuit 300 in accordance with the present invention. It includes a maximum frequency circuit formed by a current source 320 and the resistor 52 at the RM terminal of the control circuit 100 (shown in FIG. 1). The current source 320 is coupled between the supply voltage V_{CC} and the resistor 52. The maximum frequency circuit generates the maximum frequency signal V_{M} to determine the maximum switching frequency for the switching signal that determines the maximum switching frequency for the first switching signal S_{H} and the second switching signal S_{L}. A positive input of an operational amplifier 312 receives the maximum frequency signal V_{M}. A negative input of the operational amplifier 312 is connected to its output. A positive input of an operational amplifier 311 receives the level-shift signal V_{F}. A negative input of the operational amplifier 311 is connected to its output. A positive input of an operational amplifier 310 receives a signal V_{RL}. A negative input of the operational amplifier 310 is connected to its output. Through operational amplifiers 310, 311, 312, the maximum frequency signal V_{M} and the level-shift signal V_{F} are wired-OR connected to generate the trip-point signal V_{H}.

As mentioned above, it also means the maximum frequency signal V_{M} and the feedback signal V_{FB} are wired-OR connected to generate the trip-point signal V_{H}. The level of the maximum frequency signal V_{M} and the feedback signal V_{FB} determine the level of the trip-point signal V_{H}. The lowest level of the trip-point signal V_{H} is set by the signal V_{RL}. The level of the maximum frequency signal V_{M} determines the first threshold. A positive input of an operational amplifier 350 receives a signal V_{RH}. A negative input of the operational amplifier 350 is connected to its output. A current source 325 is coupled from a positive input of an operational amplifier 351 to the ground. A negative input of the operational amplifier 351 is connected to its output. A current source 330 is coupled between the supply voltage V_{CC} and the outputs of the operational amplifiers 350 and 351. The outputs of the operational amplifiers 350 and 351 generate the trip-point signal V_{H}. The highest level of the trip-point signal V_{H} is set by the signal V_{RH}. The current sources 325 and 330 are utilized to drive the trip-point signal V_{H} to be low and high.

FIG. 5 is a preferred embodiment of the phase-shift circuit 500 in accordance with the present invention. It includes a delta circuit 600 (Delta-V) generating a delta signal V_{W} in accordance with differential of the maximum frequency signal V_{M} and the level-shift signal V_{F}. It also means the delta circuit 600 generates the delta signal V_{W} in accordance with the differential of the maximum frequency signal V_{M} and the feedback signal V_{FB}. The phase modulation circuit 700 (Phase-Shift) generates a PWM signal S_{W} and determines the pulse width of the PWM signal S_{W} in accordance with the frequency signal PLS, the delta signal V_{W} and the level-shift signal V_{F}. The resistor 53 is connected to an output circuit 800 (OUT) through the RD terminal of the control circuit 100 (shown in FIG. 1). The output circuit 800 generates the switching signals S_{H}, S_{L} in accordance with the PWM signal S_{W} and the resistance of the resistor 53.

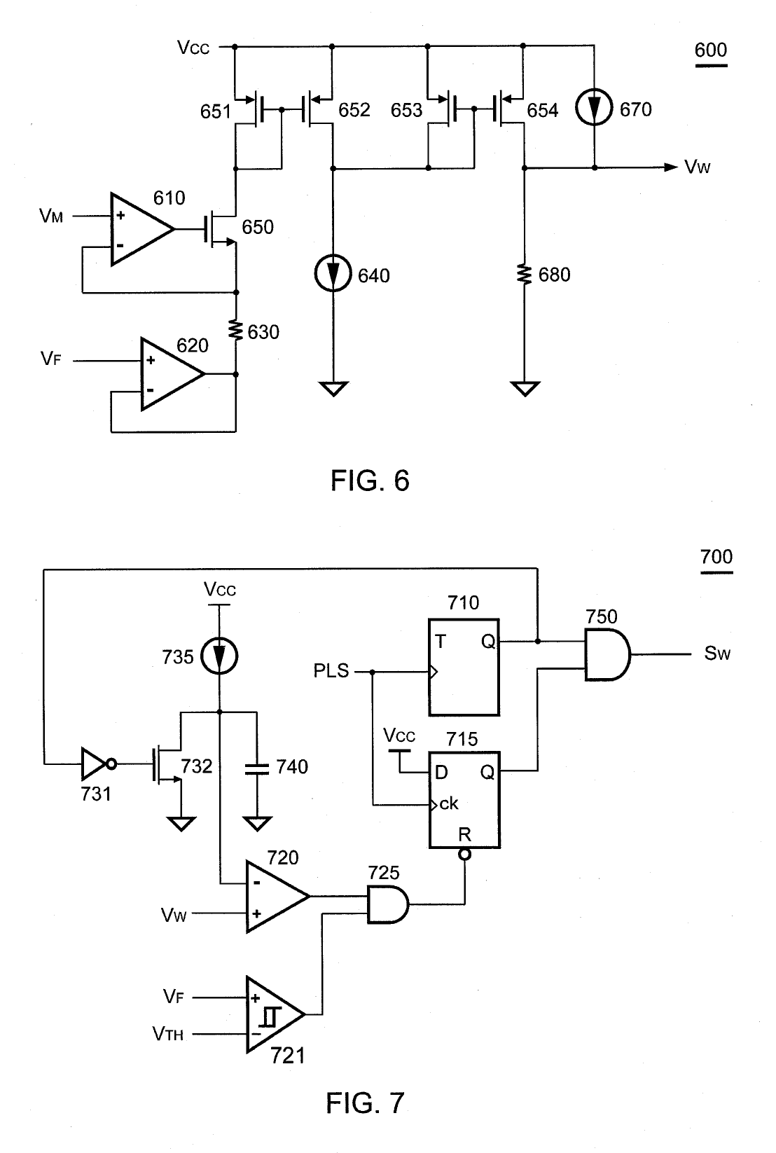

FIG. 6 is a preferred embodiment of the delta circuit 600 in accordance with the present invention. It includes a first amplifier 610, a second amplifier 620, a transistor 650, a resistor 630, a first current mirror formed by transistors 651, 652, a constant current source 640, a second current mirror formed by transistors 653, 654, a constant current source 670 and a resistor 680. A positive input of the first amplifier 610 receives the maximum frequency signal V_{M}. A negative input of the first amplifier 610 is coupled to a source terminal of the transistor 650 and one terminal of the resistor 630. An output of the first amplifier 610 is coupled to a gate terminal of the transistor 650. A positive input of the second amplifier 620 receives the level-shift signal V_{F}. A negative input of the second amplifier 620 is coupled to its output. The output of the second amplifier 620 is coupled to another terminal of the resistor 630. A drain terminal of the transistor 650 is coupled to the first current mirror.

Referring to FIG. 6, source terminals of the transistors 651 and 652 of the first current mirror are coupled to the supply voltage V_{CC}. Gate terminals of the transistors 651, 652 and drain terminals of the transistors 651, 650 are connected together. The constant current source 640 is coupled between a drain terminal of the transistor 652 and the ground. The second current mirror is coupled to the drain terminal of the transistor 652 and the constant current source 640. Source terminals of the transistors 653 and 654 of the second current mirror are coupled to the supply voltage V_{CC}. Gate terminals of the transistors 653, 654 and drain terminals of the transistors 653, 652 are connected together. The resistor 680 is coupled between a drain terminal of the transistor 654 and the ground. The constant current source 670 is coupled from the supply voltage V_{CC} to the drain terminal of the transistor 654 and the resistor 680. The drain terminal of the transistor 654 outputs the delta signal V_{W}.

The delta signal V_{W} is generated in accordance with the differential of the maximum frequency signal V_{M} and the level-shift signal V_{F}. When the level-shift signal V_{F} is decreased, the delta signal V_{W} will be decreased as well. The constant current source 670 produces a minimum value of the delta signal V_{W}. The constant current source 640 determines a maximum value of the delta signal V_{W} when the level-shift signal V_{F} is higher than the maximum frequency signal V_{M}.

FIG. 7 is a preferred embodiment of the phase modulation circuit 700 in accordance with the present invention. The frequency signal PLS is connected to clock a T flip-flop 710 and a D flip-flop 715. A D-input of the D flip-flop 715 receives the supply voltage V_{CC}. An output Q of the T flip-flop 710 and an output Q of the D flip-flop 715 are connected to inputs of an AND gate 750 to generate the PWM signal S_{W}. The T flip-flop 710 provides a 50% maximum duty cycle for the PWM signal S_{W}. The output of the T flip-flop 710 is further connected to an input of an inverter 731. The inverter 731, a transistor 732, a current source 735 and a capacitor 740 develop a ramp signal generator to generate a ramp signal in response to the enable of the output of the T flip-flop 710. One terminal of the current source 735 is coupled to the supply voltage V_{CC}. Other terminal of the current source 735 is coupled to a first terminal of the capacitor 740. A second terminal of the capacitor 740 is coupled to the ground. A drain terminal of the transistor 732 is coupled to the first terminal of the capacitor 740. A source terminal of the transistor 732 is coupled to the ground. A gate terminal of the transistor 732 is coupled to an output of the inverter 731. When the output of the T flip-flop 710 is enabled, the current source 735 charges the capacitor 740. When the output of the T flip-flop 710 is disabled, the capacitor 740 is discharged through the transistor 732 and the ground. Therefore, the ramp signal is generated at the capacitor 740.

The ramp signal is coupled to a negative input of a comparator 720. The delta signal V_{W} is supplied with a positive input of the comparator 720. The ramp signal is coupled to the comparator 720 to compare with the delta signal V_{W}. Once the ramp signal is higher than the delta signal V_{W}, an output of the comparator 720 will generate a PWM-reset signal. The output of the comparator 720 is coupled to a first input of an AND gate 725. An output of the AND gate 725 is coupled to a reset-input R of the D flip-flop 715. Through the AND gate 725, the PWM-reset signal is coupled to the reset-input R of the D flip-flop 715 to reset the D flip-flop 715 and the PWM signal S_{W}. It can achieve the pulse width modulation of the PWM signal S_{W}. The burst circuit is developed by a comparator 721 with a hysteresis to perform the burst modulation. The level-shift signal V_{F} and a second threshold V_{TH} are supplied with a positive input and a negative input of the comparator 721 respectively. An output of the comparator 721 generates a reset signal when the level-shift signal V_{F} is lower than the second threshold V_{TH}. As mentioned above, it also means the burst modulation has a hysteresis comparison. The hysteresis comparison generates the reset signal when the feedback signal V_{FB} is lower than the second threshold V_{TH}. The output of the comparator 721 is coupled to a second input of the AND gate 725. The reset signal is coupled to turn off the PWM signal S_{W} through the AND gate 725, the D flip-flop 715 and the AND gate 750.

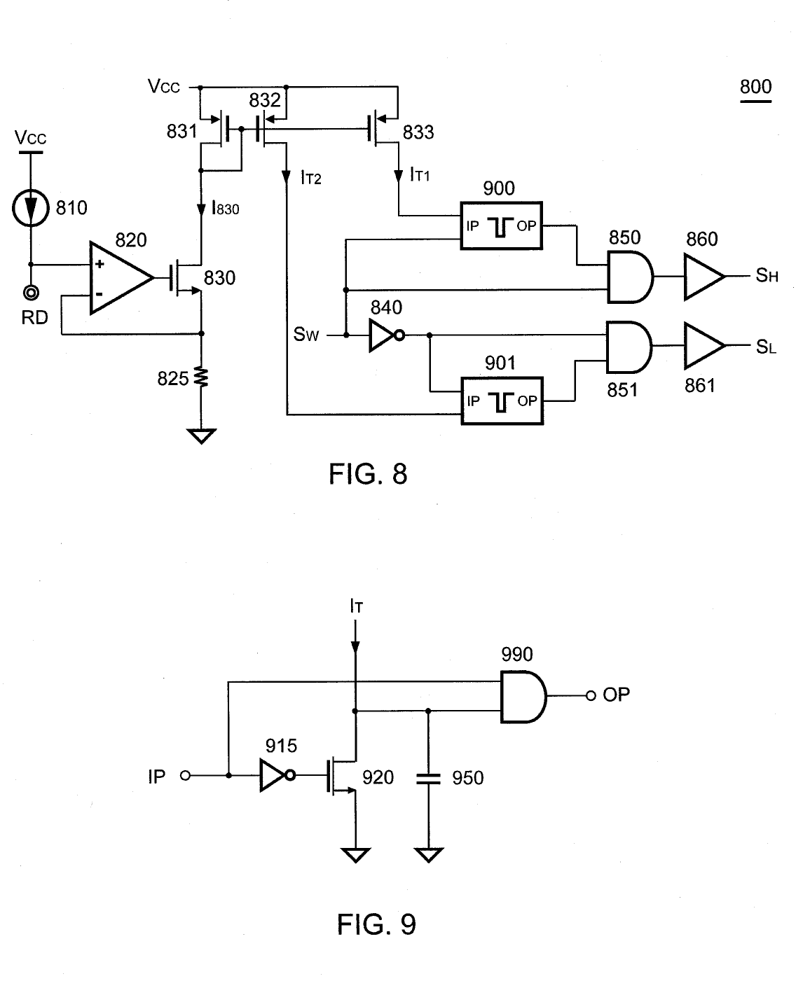

FIG. 8 is a preferred embodiment of the output circuit 800 in accordance with the present invention. The output circuit 800 includes the delay time terminal RD for programming the delay time between the on/off of the first switching signal S_{H} and the second switching signal S_{L}. As mentioned above, it also means the present invention includes a programmable delay time for programming the delay time. The resistor 53 (shown in FIG. 1) associated with a current source 810 generates a voltage at the delay time terminal RD. The current source 810 is coupled from the supply voltage V_{CC} to the resistor 53 through the delay time terminal RD. The voltage of the delay time terminal RD is connected to a positive input of an operational amplifier 820. The operational amplifier 820, a resistor 825 and a transistor 830 form a voltage-to-current converter that generates a current I₈₃₀ coupled to transistors 831, 832, 833. The positive input of the operational amplifier 820 receives the voltage of the delay time terminal RD. An output of the operational amplifier 820 is coupled to a gate terminal of the transistor 830. A negative input of the operational amplifier 820 is coupled to a source terminal of the transistor 830. The resistor 825 is connected from the source terminal of the transistor 830 to the ground. A drain terminal of the transistor 830 generates the current I₈₃₀ coupled to the transistors 831, 832, 833.

Transistors 831, 832 and 833 develop two current mirrors generating currents I_{T1} and I_{T2} coupled to delay time circuits 900 and 901 respectively. Source terminals of the transistors 831, 832 and 833 are coupled to the supply voltage V_{CC}. Gate terminals of the transistors 831, 832, 833 and drain terminals of the transistors 831, 830 are connected together. A drain terminal of the transistor 833 generates the current I_{T1} coupled to an input of the delay time circuit 900. A drain terminal of the transistor 832 generates the current I_{T2} coupled to an input of the delay time circuit 901. The delay-time circuits 900 and 901 generate the delay times for the switching signals S_{H}, S_{L}. The delay-time circuits 900, 901, an inverter 840, AND gates 850, 851 and buffers 860, 861 develop an output-drive circuit to generate the switching signals S_{H}, S_{L} in response to the PWM signal S_{W}.

The PWM signal S_{W} is connected to the delay-time circuit 900 and an input of the AND gate 850. An output of the delay-time circuit 900 is connected to another input of the AND gate 850. An output of the AND gate 850 is connected to the buffer 860 to generate the switching signal S_{H}. In response to the enable of the PWM signal S_{W}, the first switching signal S_{H} is generated after the delay time produced by the delay-time circuit 900. Furthermore, through the inverter 840, the PWM signal S_{W} is connected to the delay-time circuit 901 and an input of the AND gate 851. An output of the delay-time circuit 901 is connected to another input of the AND gate 851. An output of the AND gate 851 is connected to the buffer 861 to generate the second switching signal S_{L}. In response to the disabling of the PWM signal S_{W}, the second switching signal S_{L} is generated after the delay time is produced by the delay-time circuit 901. Therefore, the delay-time circuits 900 and 901 determine the delay times between the on/off of the first switching signal S_{H} and the second switching signal S_{IL}. The delay times help to achieve the soft switching for the transistors 10 and 20 (shown in FIG. 1).

FIG. 9 shows a preferred embodiment of delay-time circuits 900 and 901 in accordance with the present invention. The delay-time circuit includes a charge current I_{T}, an inverter 915, a transistor 920, a capacitor 950 and an AND gate 990. The charge current I_{T} means currents I_{T1} or I_{T2} shown in FIG. 8. The transistor 920 can be the N-type transistor in accordance with one embodiment of the present invention. A gate terminal of the N-type transistor 920 receives an input signal IP via the inverter 915. For the input of the delay-time circuit 900 (shown in FIG. 8), the input signal IP means the PWM signal S_{W}. For the input of the delay-time circuit 901 (shown in FIG. 8), the input signal IP also means the PWM signal S_{W} but it needs to pass through the inverter 840. A first input of the AND gate 990 receives the input signal IP as well. A source terminal of the N-type transistor 920 is coupled to the ground. A second input of the AND gate 990 is coupled to a drain terminal of the N-type transistor 920 and one terminal of the capacitor 950. The drain terminal of the N-type transistor 920 is coupled to the charge current I_{T}. The other terminal of the capacitor 950 is coupled to the ground. An output of the AND gate 990 generates an output signal OP. Therefore, the delay-time circuit receives the input signal IP to generate the output signal OP (delay time) in response to the enable of the input signal IP. The current of the charge current I_{T} and the capacitance of the capacitor 950 determine the delay time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control circuit of a resonant power converter comprising:
a frequency modulation circuit modulating a switching frequency of a switching signal in response to a feedback signal in a first operation range;
a phase-shift circuit performing a phase-shift modulation to the switching signal in response to the feedback signal in a second operation range; and
a burst circuit performing a burst modulation to the switching signal in response to the feedback signal in a third operation range;
wherein the control circuit is coupled to an output of the power converter to receive the feedback signal for regulating the output of the power converter; the control circuit is operated in the first operation range when the feedback signal is higher than a first threshold; the control circuit is operated in the second operation range when the feedback signal is lower than the first threshold and higher than a second threshold; the control circuit is operated in the third operation range when the feedback signal is lower than the second threshold.

2. The control circuit as claimed in claim 1, further comprising:
a minimum frequency circuit generating a minimum frequency signal to determine a minimum switching frequency for the switching signal; and
a maximum frequency circuit generating a maximum frequency signal to determine a maximum switching frequency for the switching signal;
wherein the maximum frequency signal and the feedback signal generate a trip-point signal; the trip-point signal and the minimum frequency signal are coupled to the frequency modulation circuit to modulate the switching frequency of the switching signal.

3. The control circuit as claimed in claim 2, wherein the maximum frequency signal and the feedback signal are wired-OR to generate the trip-point signal; the level of the maximum frequency signal and the feedback signal determine the level of the trip-point signal; the level of the maximum frequency signal determines the first threshold.

4. The control circuit as claimed in claim 2, wherein the minimum frequency signal determines a charge current for the frequency modulation circuit; the trip-point signal determines a trip-point voltage for the frequency modulation circuit; the charge current and the trip-point voltage determine the switching frequency of the switching signal.

5. The control circuit as claimed in claim 2, wherein the phase-shift circuit comprises:
a delta circuit generating a delta signal in accordance with a differential of the maximum frequency signal and the feedback signal;
a phase modulation circuit generating a PWM signal and determine the pulse width of the PWM signal in accordance with the delta signal; and
an output circuit generating a first switching signal and a second switching signal of the switching signal in accordance with the PWM signal.

6. The control circuit as claimed in claim 5, wherein the phase modulation circuit comprises a ramp signal generator to generates a ramp signal for generating a PWM-reset signal in response to the ramp signal and the delta signal, the PWM-reset signal is coupled to turn off the PWM signal.

7. The control circuit as claimed in claim 1, wherein the switching signal comprises a first switching signal and a second switching signal; the first switching signal contrasts with the second switching signal; the pulse width of the first switching signal is decreased and the pulse width of the second switching signal is increased during the phase-shift modulation.

8. The control circuit as claimed in claim 1, further comprising a delay time terminal for programming a delay time between the on/off of a first switching signal and a second switching signal of the switching signal.

9. The control circuit as claimed in claim 1, wherein the burst circuit comprises a comparator with a hysteresis; the comparator generates a reset signal when the feedback signal is lower than the second threshold; the reset signal is coupled to turn off the switching signal.

10. The control circuit as claimed in claim 1, further comprising a level-shift circuit coupled to the output of the power converter to receive the feedback signal for generating a level-shift signal, wherein the level-shift signal is correlated to the feedback signal, the phase-shift circuit performs the phase-shift modulation in response to the level-shift signal in the second operation range, the burst circuit performs the burst modulation in response to the level-shift signal in the third operation range.

11. A method for the control of a resonant power converter comprising:
modulating a switching frequency of a switching signal in response to a feedback signal in a first operation range;
performing a phase-shift modulation to the switching signal in response to the feedback signal in a second operation range; and
performing a burst modulation to the switching signal in response to the feedback signal in a third operation range;
wherein the feedback signal is coupled to an output of the power converter and is used for regulating the output of the power converter; the control is operated in the first operation range when the feedback signal is higher than a first threshold; the control is operated in the second operation range when the feedback signal is lower than the first threshold and higher than a second threshold; the control is operated in the third operation range when the feedback signal is lower than the second threshold.

12. The method as claimed in claim 11, further comprising:
generating a minimum frequency signal to determine a minimum switching frequency for the switching signal; and
generating a maximum frequency signal to determine a maximum switching frequency for the switching signal;
wherein the maximum frequency signal and the feedback signal generate a trip-point signal; the trip-point signal and the minimum frequency signal are coupled to modulate the switching frequency of the switching signal.

13. The method circuit as claimed in claim 12, wherein the maximum frequency signal and the feedback signal are wired-OR to generate the trip-point signal; the level of the maximum frequency signal and the feedback signal determine the level of the trip-point signal; the level of the maximum frequency signal determines the first threshold.

14. The method as claimed in claim 12, wherein the minimum frequency signal determines a charge current; the trip-point signal determines a trip-point voltage; the charge current and the trip-point voltage determine the switching frequency of the switching signal.

15. The method as claimed in claim 12, wherein the phase-shift modulation comprises:
generating a delta signal in accordance with a differential of the maximum frequency signal and the feedback signal;
generating a PWM signal and determine the pulse width of the PWM signal in accordance with the delta signal; and
generating a first switching signal and a second switching signal of the switching signal in accordance with the PWM signal.

16. The method as claimed in claim 15, further generating a ramp signal for generating a PWM-reset signal in response to the ramp signal and the delta signal, wherein the PWM-reset signal is utilized to turn off the PWM signal.

17. The method as claimed in claim 11, wherein the switching signal comprises a first switching signal and a second switching signal; the first switching signal contrasts with the second switching signal; the pulse width of the first switching signal is decreased and the pulse width of the second switching signal is increased during the phase-shift modulation.

18. The method as claimed in claim 11, further comprising a programmable delay time for programming a delay time between the on/off of a first switching signal and a second switching signal of the switching signal.

19. The method as claimed in claim 11, wherein the burst modulation comprises a hysteresis comparison, the hysteresis comparison generates a reset signal when the feedback signal is lower than the second threshold; the reset signal is coupled to turn off the switching signal.

20. The method as claimed in claim 11, further receiving the feedback signal for generating a level-shift signal, wherein the level-shift signal is correlated to the feedback signal, the phase-shift modulation is performed in response to the level-shift signal in the second operation range, the burst modulation is performed in response to the level-shift signal in the third operation range.
